(19) United States
(12) Patent Application Publication
(10) Pub. No.: US 2015/0211746 A1
(43) Pub. Date: Jul. 30, 2015

(54) COOKING ACCESSORY FRAME

(71) Applicant: Brian Keith Murdock, Charlotte, NC (US)

(72) Inventor: Brian Keith Murdock, Charlotte, NC (US)

(21) Appl. No.: 14/168,658

(22) Filed: Jan. 30, 2014

(51) Int. Cl. F24C 15/10; A23L 1/01

(52) U.S. Cl. CPC F24C 15/107; A23L 1/01

(57) ABSTRACT

A cooking accessory frame may include a base component and an upper component. In certain embodiments, the base component and upper component may be ring shaped. The upper component may attach to the base component, and in certain embodiments, by a plurality of support struts. A heat diffuser plate may attach to the upper component. In certain embodiments, the heat diffuser plate may include a main plate section and a plurality of spokes. One end of the plurality of spokes may attach to an inner surface of the upper component, and another end of the plurality of spokes may attach to the main plate section. The cooking accessory frame may be placed in between a heat source and a cooking vessel to provide distance from the heat and to allow for the heat to spread along the bottom of the cooking vessel for a more even cooking experience.

### BACKGROUND OF THE INVENTION

The present invention relates to cooking accessories and, more particularly, to a cooking accessory frame.

Currently on gas and electric cooking devices food can burn due to the proximity of the heat to the food. Devices currently do not raise the pot or cooking device off of the burner and are made of a thin metal.

As can be seen, there is a need for a cooking accessory frame that raises the cooking vessel above a heat source and allows cooking by indirect heat.

### SUMMARY OF THE INVENTION

In one aspect of the present invention, a cooking accessory frame comprises: a base component; an upper component attached to the base component; and a heat diffuser plate attached to the upper component.

In another aspect of the present invention, a cooking accessory frame comprises: a ring shaped base component; a ring shaped upper component attached to the base component; and a heat diffuser plate attached to the upper component, wherein the heat diffuser plate comprises a main plate section and a plurality of spokes, wherein one end of the plurality of spokes attaches to an inner surface of the upper component, and the other end of the plurality of spokes attaches to the main plate section.

In another aspect of the present invention, a method of providing heat from a distance to a cooking vessel comprises: placing a cooking accessory frame on a stove top, wherein the cooking accessory frame comprises a base component, an upper component attached to the base component, and a heat diffuser plate attached to the upper component; placing a cooking vessel on top of the cooking accessory frame; and initiating heat from the stove top, wherein the heat spreads along the bottom of the cooking vessel.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a top perspective view of an exemplary embodiment of the present invention;

FIG. 3 is a bottom perspective view of an exemplary embodiment of the present invention;

FIG. 4 is a top view of an exemplary embodiment of the present invention;

FIG. 5 is a side view of an exemplary embodiment of the present invention; and

FIG. 6 is a section view of an exemplary embodiment of the present invention along line 6-6 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cooking accessory frame that may include a base component and an upper component. In certain embodiments, the base component and upper component may be ring shaped. The upper component may attach to the base component, and in certain embodiments, by a plurality of support struts. A heat diffuser plate may attach to the upper component. In certain embodiments, the heat diffuser plate may include a main plate section and a plurality of spokes. One end of the plurality of spokes may attach to an inner surface of the upper component, and another end of the plurality of spokes may attach to the main plate section. The cooking accessory frame may be placed in between a heat source and a cooking vessel to provide distance from the heat and to allow for the heat to spread along the bottom of the cooking vessel for a more even cooking experience.

The present invention raises cooking vessels high off the burner to prevent the burning of food. The heat diffuser plate may allow for the heat to radiate around a cooking vessel, such as a pot or a pan, to promote an even heat distribution along a bottom of the cooking vessel.

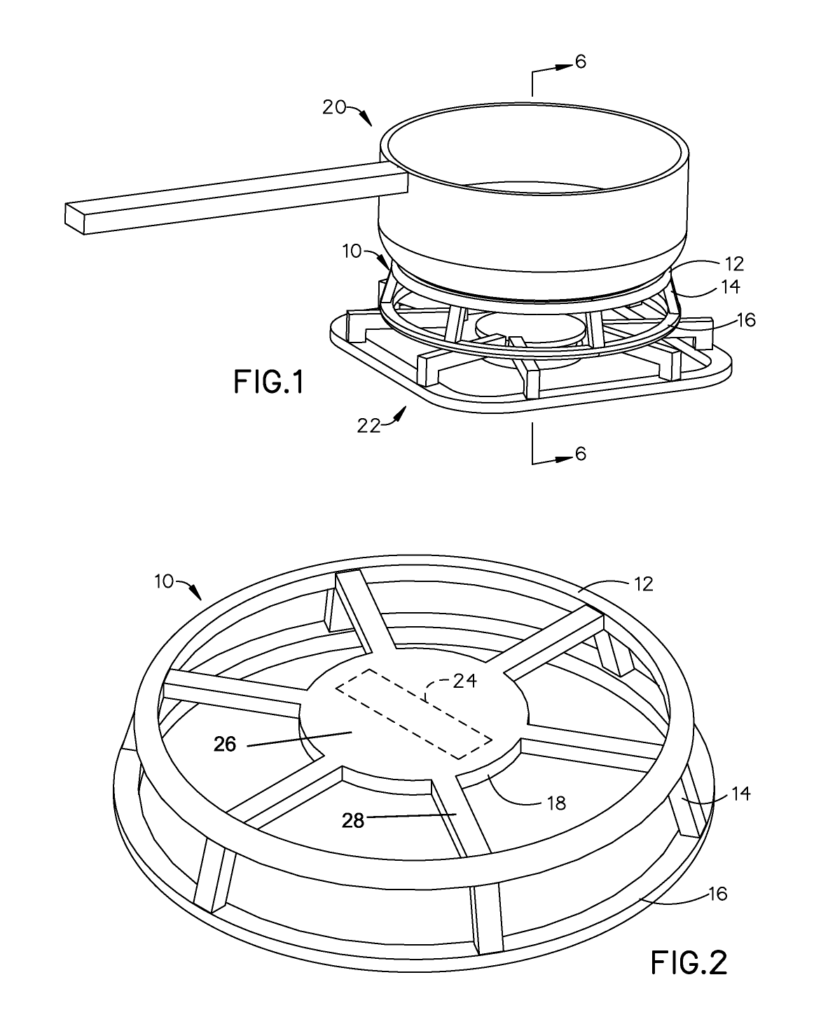

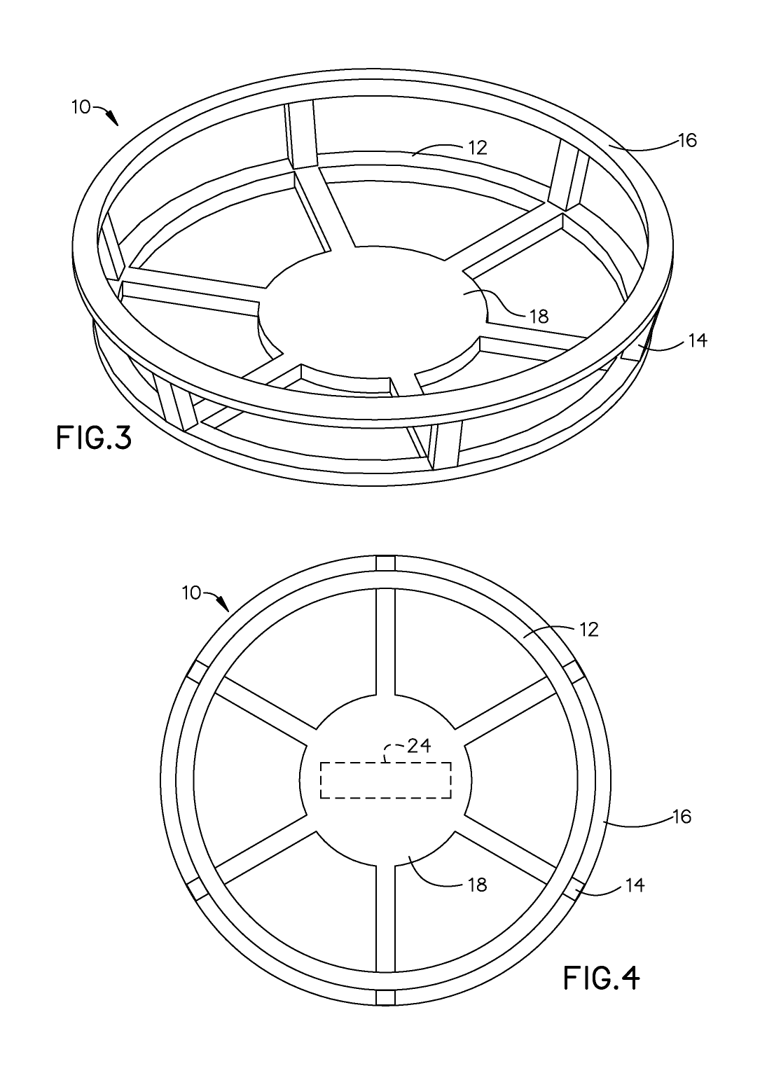

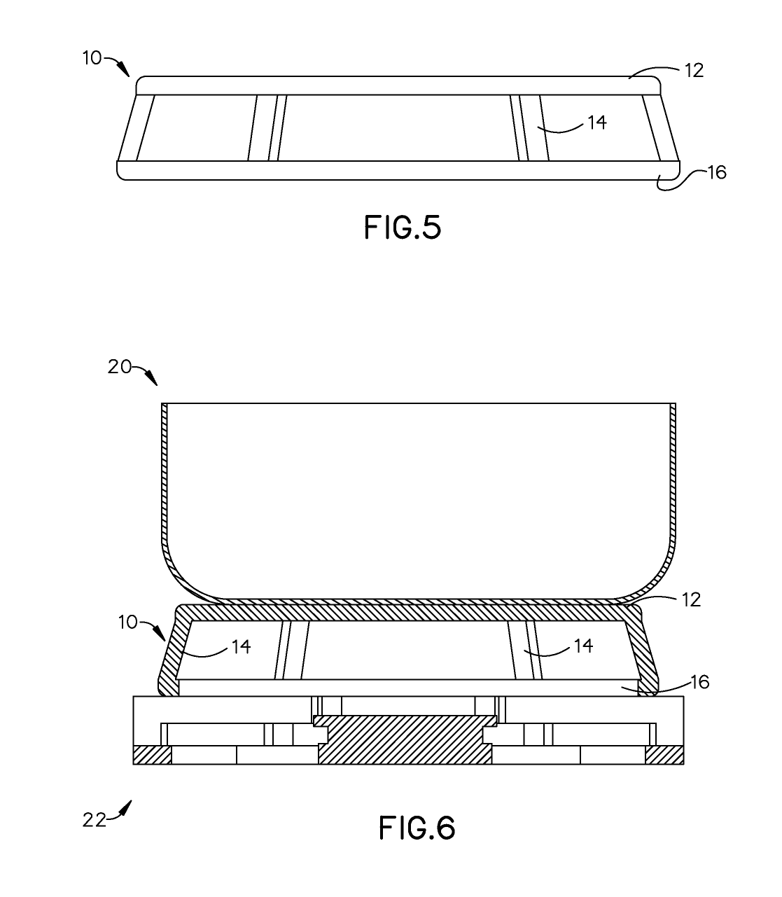

As is illustrated in FIGS. 1 through 6, the present invention 10 may include a base component 16. In certain embodiments, the base component 16 may be ring shaped or the like. An upper component 12 may be attached to the base component 16. In certain embodiments, the upper component 12 may be ring shaped or the like. In certain embodiments, the upper component 12 may be attached to the base component 16 by a plurality of support struts 14. Surrounded by, and attached to, the upper component 12 may be a heat diffuser plate 18. In certain embodiments, the heat diffuser plate 18 may have a main plate section 26 and a plurality of spokes 28 radiating from the main plate section 26. The plurality of spokes 28 may attach to an inner surface 30 of the upper component 12. The main plate section 26 may be substantially centered within the space created by the upper component 12, with one end of the plurality of spokes 28 attaching to the upper component 12 and another end of the plurality of spokes 28 attaching to the main plate section 26.

A method of making the cooking accessory frame 10 may include the following. A cast of the cooking accessory frame 10 may be made. In certain embodiments, an investment cast, a sand cast or the like may be used. A pattern may be made of the cooking accessory frame 10, the pattern may then be pressed in a sand mold, and then molten metal may be poured in the sand mold, allowed to be cooled and then the finished cooking accessory frame 10 may be released from the sand. In certain embodiments, the present invention may raise the cooking vessel 20 approximately 1½ inch above the stove top 22 or similar heated surface. The material for the cooking accessory frame 10 may be cast steel, iron or the like.

In certain embodiments, the base component 16 may be placed directly on a stove top 22. The plurality of support struts 14 may help to raise the cooking vessel 20 higher off the heat than if the cooking vessel 20 was placed on the stove top 22. The raising of the cooking vessel 20 allows for providing heat from a distance to a cooking vessel 20. The upper component 12 may be used as a location to set the cooking vessel 20. In certain embodiments, the heat diffuser plate 18 may help to radiate the gas flame or heat outward to promote even heat so that there may not be a hot spot on the bottom of the cooking vessel 20. A person may place the cooking accessory frame 10 onto the stove top 22. The cooking vessel 20 may be placed on top of the cooking accessory frame 10. Heat may be initiated, which may radiate out to multiple area along the bottom of the cooking vessel 20 due to the plurality of spokes 28 and the heat diffuser plate 18. In certain embodiments, a section 24 on the heat diffuser plate may be used to allow a logo placement.

It should be understood, of course, that the foregoing relates to exemplary embodiments of the invention and that modifications may be made without departing from the spirit and scope of the invention as set forth in the following claims.

What is claimed is:

1. A cooking accessory frame comprising:
a base component;
an upper component attached to the base component; and
a heat diffuser plate attached to the upper component.

2. The cooking accessory frame of claim 1, wherein the base component is ring shaped.

3. The cooking accessory frame of claim 1, wherein the upper component is ring shaped.

4. The cooking accessory frame of claim 1, wherein the heat diffuser plate comprises a main plate section and a plurality of spokes, wherein one end of the plurality of spokes attaches to an inner surface of the upper component, and the other end of the plurality of spokes attaches to the main plate section.

5. The cooking accessory frame of claim 1, wherein the upper component attaches to the base component by a plurality of support struts.

6. A cooking accessory frame comprising:
a ring shaped base component;
a ring shaped upper component attached to the base component; and
a heat diffuser plate attached to the upper component, wherein the heat diffuser plate comprises a main plate section and a plurality of spokes, wherein one end of the plurality of spokes attaches to an inner surface of the upper component, and the other end of the plurality of spokes attaches to the main plate section.

7. A method of providing heat from a distance to a cooking vessel comprising:
placing a cooking accessory frame on a stove top, wherein the cooking accessory frame comprises a base component, an upper component attached to the base component, and a heat diffuser plate attached to the upper component;
placing a cooking vessel on top of the cooking accessory frame; and
initiating heat from the stove top, wherein the heat spreads along the bottom of the cooking vessel.

8. The method of claim 7, wherein the base component is ring shaped.

9. The method of claim 7, wherein the upper component is ring shaped.

10. The method of claim 7, wherein the heat diffuser plate comprises a main plate section and a plurality of spokes, wherein one end of the plurality of spokes attaches to an inner surface of the upper component, and the other end of the plurality of spokes attaches to the main plate section.
